(19) United States
(12) Patent Application Publication
(10) Pub. No.: US 2002/0016830 A1
(43) Pub. Date: Feb. 7, 2002

(54) Communication method between server and client of a network

(76) Inventor: Jurgen Nicolai, Sulzbach/Murr (DE)

Correspondence Address: Walter A. Hackler, Ph.D., Suite B., 2372 S.E. Bristol, Newport Beach, CA, 92660-0755, US

(21) Appl. No.: 09/912,920

(22) Filed: Jul. 25, 2001

(30) Foreign Application Priority Data
Jul. 29, 2000 (EP) 00 116 484.7

(51) Int. Cl. G06F 15/16

(52) U.S. Cl. 709/219; 709/203

(57) ABSTRACT

In a communication method between a network client and a network server, wherein a network document requested by the network client is sent from the network server to the network client and is displayed by a browser of the network client to the user for processing, the changes and supplements on the network client carried out by the user on the network document on the network client, are recorded via software and stored in the network server as user-specific data. When the network document is loaded again by the user, the network document generated during previous loading on the network client through interaction of the user is restored by means of the stored user-specific data. In this fashion, every client can obtain his/her individual network page every time he/she loads a network document.

### BACKGROUND OF THE INVENTION

The invention concerns a communication method between a network client and a network server, wherein a network document requested by the network client is sent from the network server to the network client and is displayed by a browser of the network client to the user for processing, and a computer product suitable for carrying out this communication method.

The source of documents on the Internet is the so-called server. In the world-wide web (www), the www or web pages are provided by a web server wherein web pages can be found on the internet by means of pointers which are introduced with HTML (Hypertext Markup Language) into the stored documents. The supplied web page is displayed to the user by means of a web browser (i.e. the tool for navigating and modifying on the Internet).

A request by an Internet user on the Internet is processed in principle as follows:

1. The user sends a HTTP request (HTTP: HyperText Transfer Protocol) to the web server via his/her network computer (so-called client).

2. The web server loads down the requested web page via a file system or produces the web page in a different fashion.

3. This web page is returned to the client via HTTP.

4. The web browser of the client displays the web page.

5. The user works with the web page.

The data entered by the user will get lost if no further technical means have been taken. HTTP is a state-free protocol. The method described can be “individualized” only to a limited degree since all clients use the same web page in principle. When a web page has been called up again, the user will receive this web page always with the same layout without taking into consideration entries or changes already entered by the user during the last call which means that the requested web page is generated statically.

To prevent data input by the user from getting lost, techniques such as e.g. cookies or storing of form data in a database are known. In any case, only the “basic” data (e.g. entries into the fields) is stored and not the state of the entire page which, in addition to the basic data, also contains the previous page, typeface and size, position of the elements and of the cursor etc.

It is therefore the underlying purpose of the invention to improve a method of the above-mentioned type such that when the same user calls up again a certain network document, all the previous changes and entries carried out on this network document by the user will be taken into consideration, and to provide a corresponding computer product. Changes and entries include, in addition to input data, also changes to the layout (textual content, typefaces, positions of the elements, colors, background, images etc.) and embedding of the page into the entire context (e.g. previous pages and possible following pages).

### SUMMARY OF THE INVENTION

This object is achieved in accordance with the invention in that the changes and supplements carried out by the user on the network document on the network client are recorded on the network client via software and stored in the network server as user-specific data and that during new loading of the network document through the user, the network document, which has been created during a previous loading on the network client through interaction of the user, is restored by means of the stored user-specific data. In terms of Internet, this means that the total state of a web page which a user has generated through interaction with the network client at an earlier time, can be restored. The web page to be restored is thereby dynamically generated.

The inventive method permits to provide each client his/her individual network page when reloading a network document. This is usually the pages generated during the last session of the user on the network client. This permits individualization of the web pages on the Internet which has not been possible up to now. In accordance with the invention, anything that can be created in the web browser and/or modified through program control, can be restored. The Internet or the individual web pages become client-specific, since each client obtains again his/her individual data and settings from previous sessions. All the dialogues from a previous session can be taken into consideration when restoring the web page and also during a further dialog or further dialog control with the user, e.g. with respect to the layout of dialog pages.

The changes and supplements carried out by the user on the network document on the network client are preferably intermediately stored on the network client in particular in the main storage or on the fixed disk and transferred to the network server after processing of the network document through the user has been concluded. The network server preferably provides a special region for the user-specific data in a database.

When a user loads a network document for the first time, the network client or the user should be identified and a password should be allocated. The network server generates a special region in the database for this client wherein the user-specific data is stored. This region is called “push-back region”. As soon as the user is identified during the next contact, it is possible to directly display the client-generated web pages of the previous contact.

The document which has been changed or supplemented by the user is preferably recorded on the network client and transferred in a browser-independent format, in particular in a browser-independent XML format, JavaScript or serialized Java objects to the network server and stored therein. The recorded changes can be stored alternatively as pure HTML, which has, however the consequence that usually data exchange between different browser versions is not possible.

The stored user-specific data of the network server can be interpreted via e.g. JavaScript or Java on the network client and a format which is readable for the respective user (e.g. HTML code) can be produced therefrom.

It is possible to generate HTML pages via script languages and/or Java by means of the inventive method on the network client which are then returned to the web server in a browser-neutral format. Generation of complete HTML pages on the network client and returning of these pages permit reproduction of the complete previous state of a web page which represents a reversal of the previous principle on the Internet where HTML pages are stored and/or generated on the network server and then sent to the network client. In the inventive method, the network client generates new HTML pages which are then sent to the network server.

The invention also concerns a computer product which is suited for carrying out all the steps of the communication method described above. This computer product may be a computer program or a computer-readable storage medium.

Further advantages of the invention can be extracted from the description and the drawing. The features mentioned above and below can be used in accordance with the invention either individually or collectively in any arbitrary combination. The embodiment shown and described is not to be understood as exhaustive enumeration but rather has exemplary character for describing the invention.

### BRIEF DESCRIPTION OF THE DRAWINGS

FIG. 1 schematically shows the temporal progression of the inventive communication method during a first contact between a client and a web server; and

FIG. 2 schematically shows the temporal progression of the inventive communication method during a second contact or each further contact between the client and the web server.

### DESCRIPTION OF THE PREFERRED EMBODIMENT

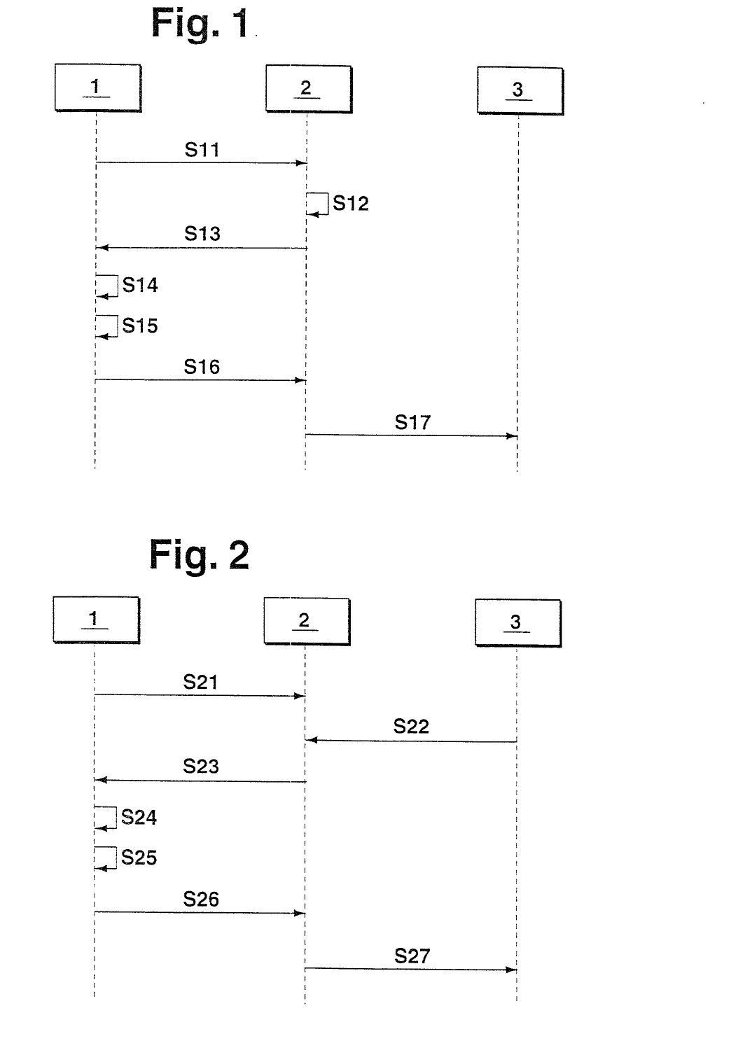

FIG. 1 describes the temporal scenario which is carried out on the Internet between a client 1 and a web server 2 during a first contact.

The client 1 makes a HTTP request for a web page to a web server 2 (step S11). The web server 2 loads or generates this web page (Step S12) which is then returned to the client 1 via HTTP (step S13) and is displayed by the web browser of the client 1 (step S14). The user works with the web page (step S15) wherein in new browsers such as IE 4/5, NS4/Mozilla changes can be carried out on the web pages via DHTML on the client thereby using JavaScript/JScript and/or JAVA. The pages changed on the client 1 in this fashion can be requested via these languages. For IE4/5/Mozilla, changes can be requested directly via the browser; with NS4, changes on the web page must be recorded by a corresponding framework. These recordings of changes generated on the client 1 require use of a comprehensive software which is loaded at the start of a session as Java-Script/JScript and/or Java applets by the web server 2. As a result, each change is recorded on the client 1. The recorded changes are returned to the web server 2 in a browser-independent format (step S16) wherein returning of the recorded changes is carried out via a HTML form, a Java applet or an ActiveX-Control or other possible mechanisms of communication between client 1 and web server 2. The changes returned to the web server 2 are stored under a client identity such as e.g. session identity (SessionId(entity)) consisting of user identity (UserId(entity)) and password in a database 3 (step S17). If the client 1 has not been identified yet, application is possible here via UserId and password or other mechanisms. The web server 2 generates a special region in the database 3 for this client 1, in which the user-specific data is stored. This region is called “push-back-region”. HTTP can be used as transmission protocol, wherein the port of the web server 2 or a special data port can be used.

FIG. 2 describes the temporal scenario which is carried out between the client 1 and the web server 2 during a second contact or each further contact.

The client 1 makes a HTTP request for a web page to the web server 2 and is identified on the web server 2, e.g. via UserId and password (step S21). Identification can take place via UserId and password, cookies or other techniques such as smartcards. The web server 2 checks whether a push back region has been created in the database 3 for this client or user. If not, this is a first contact and the above-described steps S12 through S17 are carried out. If yes, the web server 2 checks whether the request can be loaded from the push back region of the database 3. If not, a generic web page is returned to the client 1 like during a first contact. If a push back region is present, the client-specific data is loaded (step S22) and transmitted to the client 1 in the generic XML/JavaScript format (step S23). As an alternative, pure HTML can be stored in the push back region and returned to the client 1, however, data transmission between different browser versions is usually no longer possible. This data is interpreted on the client 1 via JavaScript or Java and HTML code is dynamically generated on the client 1 (step S24), wherein browser specifications are dealt with herein. The user can work with the web page via the browser (step S25). The changes made by the user are returned to the web server 2 like during a first contact (step S26) and stored in the database 3 under the client identity (step S27).

I claim:

1. Communication method between a network client and a network server, wherein a network document requested by the network client is sent from the network server to the network client and displayed by a browser of the network client to the user for processing, wherein the changes and supplements carried out by the user on the network document on the network client, are recorded on the network client via software and stored in the network server as user-specific data and wherein, when the network document is loaded again by the user, the network document generated during previous loading on the network client through the interaction with the user, is restored on the basis of the stored user-specific data.

2. Communication method according to claim 1, wherein the changes and supplements carried out by the user on the network document are at first intermediately stored on the network client in particular in the main storage or on the fixed disk.

3. Communication method according to claim 1, wherein the network server creates a specific region in a database for the user-specific data.

4. Communication method according to claim 1, wherein in a first loading of a network document, the network client or the user is identified.

5. Communication method according to claim 1, wherein the document changed or supplemented by the user is recorded on the network client and is stored in the network server in a browser-independent format, in particular in XML.

6. Communication method according to claim 1, wherein the stored user-specific data of the network server is interpreted on the network client and a format is generated therefrom which the network browser can read.

7. Communication method according to claim 1, wherein the changes and supplements carried out by the user on the network document are at first intermediately stored on the network client in particular in the main storage or on the fixed disk, wherein the network server creates a specific region in a database for the user-specific data, wherein in a first loading of a network document, the network client or the user is identified, wherein the document changed or supplemented by the user is recorded on the network client and is stored in the network server in a browser-independent format, in particular in XML, and wherein the stored user-specific data of the network server is interpreted on the network client and a format is generated therefrom which the network browser can read.

8. Computer product which is suitable for carrying out all the steps of the communication method according to claim 1, if the program runs on a computer.

9. Computer product according to claim 8, wherein the computer product is a computer program.

10. Computer product according to claim 8, wherein the computer product is a computer-readable storage medium.
